(19) United States
(12) Patent Application Publication
(10) Pub. No.: US 2009/0070301 A1
(43) Pub. Date: Mar. 12, 2009

(54) Document search tool

(75) Inventors: Stuart A. McLean, Liberty Township, OH (US); Harriet Meehan, Dayton, OH (US); Phillip R. Jacobs, Dayton, OH (US); Charles M. Greenwald, JR., Dayton, OH (US); Don P. Steiner, Centerville, OH (US); Mark Edwards, London (GB)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: LexisNexis Group

(21) Appl. No.: 12/230,313

(22) Filed: Aug. 27, 2008

Related U.S. Application Data
(60) Provisional application No. 60/935,714, filed on Aug. 28, 2007.

(51) Int. Cl. G06F 7/06; G06F 17/30; G06F 15/16

(52) U.S. Cl. 707/3; 709/207; 707/E17.014

(57) ABSTRACT

A method of automatically sending an alert message when the status of one or more documents has changed is disclosed. The method includes receiving, by a computer system, instructions from a user to monitor the status of a first type of information for a first selected document. The method further includes monitoring, by the computer system, the status of the first type of information for the first selected document. The method also includes, when the status of the first type of information for the first selected document has changed, sending, by the computer system, an alert message to the user to indicate that the status of the document has changed.

### CLAIM TO PRIORITY

This application claims the benefit of priority from U.S. Provisional Application No. 60/935,714, filed on Aug. 28, 2007, which is incorporated herein by reference in its entirety.

### TECHNICAL FIELD

The present disclosure is directed in general toward a document search tool, and particularly toward a patent search tool.

### BACKGROUND

Various databases and search tools exist for searching for and reviewing documents, such as patent-related documents, over a computer network. For example, the U.S. Patent and Trademark Office (USPTO) has its own database and search tools for searching patents online, as do foreign patent agencies. Other search tools exist as well, such as, for example, MicroPatent™, PatBase™, and Delphion™. These search tools typically permit users to search for patent-related documents across multiple patent authorities (e.g., USPTO, EPO, JPO, etc.), using search terms and other criteria.

Existing search tools provide a number of known features that aid in the search experience. For example, certain search tools provide a feature that periodically over time runs the same search query in order to determine and inform a user whether new documents matching the search query appear in an updated results set. Other tools permit a user to perform an analysis of search results, and display the analysis results to the user. Certain search tools permit document translation for foreign-language documents. However, these and other search tool features leave room for improvement in order to provide a more user-friendly and effective search tool.

### SUMMARY

The embodiments disclosed herein include new and improved search tool features that enhance the user searching experience and provide for more manageable, effective, and viewable searches, and better targeted search results.

In one embodiment, a computer system is disclosed. The computer system includes one or more processors, one or more storage devices storing patent-related documents, and stored instructions. Consistent with certain embodiments, the instructions are configured to instruct the computer system to perform certain steps. The steps may include receiving a search query from a user computer system, performing a search for patent-related documents based on the search query, and retrieving a results set of documents as a result of the search. The retrieved results set may include, for at least one of the patent-related documents, a plurality of patent family duplicate documents. The steps further include removing one or more patent family duplicate documents associated with the at least one of the patent related documents prior to returning the patent family duplicate documents to the user computer system, thereby creating a second results set that does not include the removed one or more patent family duplicate documents. The steps additionally include providing a user interface for viewing the second results set, the user interface including at least a first display area for displaying different view formats for documents in the second results set.

In another embodiment, a method of automatically sending an alert message when the status of one or more patents has changed is disclosed. The method includes receiving, by a computer system, instructions from a user to monitor the status of a first type of information for a first selected patent. The method further includes monitoring, by the computer system, the status of the first type of information for the first selected patent. The method also includes, when the status of the first type of information for the first selected patent has changed, sending, by the computer system, an alert message to the user to indicate that the status of the patent has changed.

In a further embodiment, a method of searching for documents is disclosed. The method includes receiving, by a computer system, an indication of a selected set of documents to analyze, the documents including a plurality of fields of information. The method further includes receiving, by the computer system, an indication of a first selected field of the plurality of fields, and in response to receiving the indication of the selected set of documents and the indication of first selected field, providing, by the computer system, a first graphical display that categorizes the first selected field into a plurality of first sub-categories, and graphically displays the first sub-categories. The method also includes receiving, by the computer system, a selection of a portion of the first graphical display or of textual information associated with the portion of the first graphical display, thereby receiving a selection of one of the first sub-categories of the first selected field, and in response to receiving the selection, providing, by the computer system, a list of documents that include information common to the selected first sub-category.

It is to be understood that both the foregoing general description and the following detailed description are exemplary and explanatory only and are not restrictive of the embodiments claimed.

### BRIEF DESCRIPTION OF THE DRAWINGS

The accompanying drawings, which are incorporated in and constitute a part of this disclosure, illustrate various disclosed embodiments. In the drawings:

FIG. 1 illustrates an exemplary system for implementing a search tool, consistent with certain disclosed embodiments;

FIGS. 2a-2p illustrate different portions of an exemplary graphical user interface (GUI) for implementing a search tool, consistent with certain disclosed embodiments; and

FIGS. 3a-3b illustrate methods of using a search tool, consistent with certain disclosed embodiments.

### DETAILED DESCRIPTION

Reference will now be made in detail to the disclosed embodiments, examples of which are illustrated in the accompanying drawings. Wherever possible, the same reference numbers will be used throughout the drawings to refer to the same or like parts.

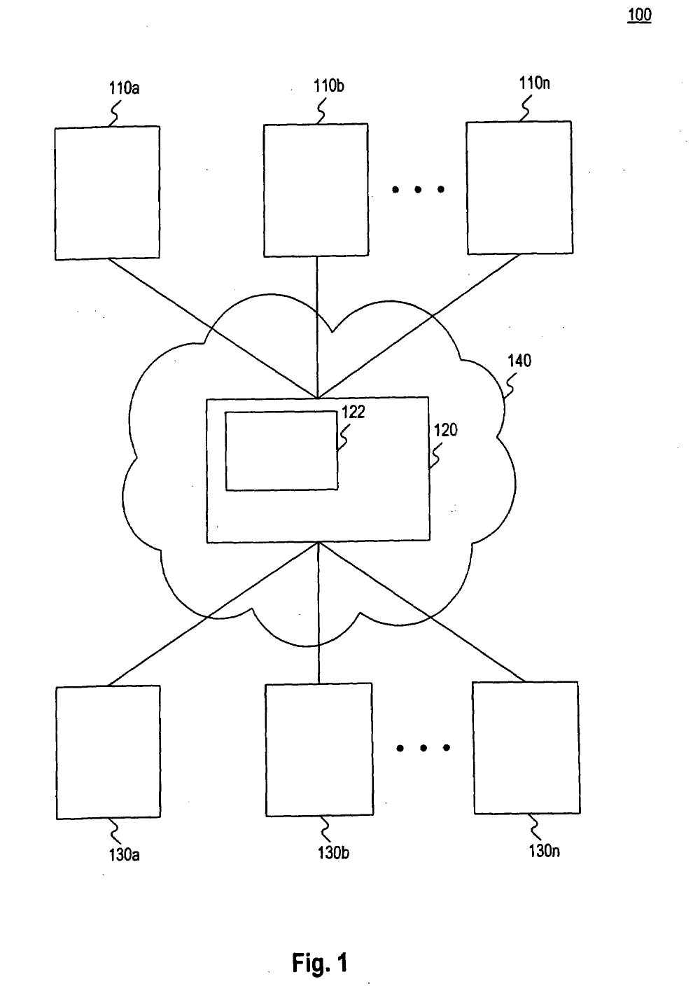

FIG. 1 depicts a system 100 on which the disclosed search tool may be implemented. System 100 may include, for example, source computer systems 110a-110n, central computer system 120, which includes search tool 122, user computer systems 130a-130n, and network 140. System 100 may include additional components as well.

In one embodiment, source computer systems 110a-110n may include any number of searchable computer systems that each serve as a patent authority storing patent-related documents and permitting searching and retrieval of the documents. Each of source computer systems 110a-110n may be implemented by one or more computers (e.g., servers), including one more searchable large capacity storage memory systems, one or more stored databases including information associated with patent-related documents, one or more processors, and other known components of a searchable information storage system. In one embodiment, each of source computer systems 110a-110n may be owned by and/or operated by a patent authority (e.g., USPTO, EPO, JPO, or other country's or organization's patent agency), or may be operated by another privately-owned patent information distribution entity.

Source computer systems 110a-110n may be configured to communicate with central computer system 120 via one or more known communication media (e.g., fiber optic or electric cable, wireless communication system, etc.), network interfaces (e.g., Ethernet or other network interface card), and communication protocols (e.g., TCP/IP, UDP/IP, etc.). In one embodiment, source computer systems 110a-110n communicate with central computer system 120 over network 140. Network 140 may be any computer network capable of connecting source computer systems 110a-110n, central computer system 120, and user computer systems 130a-130n. For example, in one embodiment, network 140 is a computer network such as the Internet.

Central computer system 120 may include one or more computers configured to communicate both with source computer systems 110a-110n and user computer systems 130a-130n. Central computer system 120 may include any components typically associated with a search and retrieval information system, such as one or more processors, one or more memory storage devices, and one or more computer-readable media storing computer-readable instructions for implementing a search tool, such as search tool 122. The instructions may be implemented using one or more sets of computer language code (e.g., C++, Java, XML, etc.). For example, in one embodiment, central computer system 120 may be an SQL server system that collects and stores patent-related documents and information from source computer systems 110a-110n, and includes search tool 122 to allow users to search for, retrieve, and analyze documents without having to access source computer systems 110a-110n in real-time.

Search tool 122 may include computer-readable instructions implemented via one or more computer programs that permit users to search for, retrieve, and analyze patent-related documents according to the methods described herein. For example, in one embodiment, search tool 122 includes instructions for implementing a user interface, instructions for processing requests and commands received from a user via the user interface, and additional instructions for retrieving information and performing analyses of patent-related documents, as described further below. As such, search tool 122 provides the users of user computer systems 130a-130n with a user interface for initiating searches and reviewing results, and provides central computer system 120 with a search engine for receiving search queries and analysis requests, and returning results and performing analyses in response. The instructions may be carried out, in certain embodiments, using software products and platforms such as, for example, Java™, Oracle™, AJAX™, IBM Websphere™, Adobe Flex™, etc.

User computer systems 130a-130n may include one or more desktop computers, laptop computers, personal digital assistants (PDAs), cellular phones, or other processing devices capable of carrying out the methods disclosed herein. For example, in one embodiment, a user computer system 130a is a computer including one or more processors, one or more memory storage devices, one or more input devices (e.g., keyboard, mouse, touch pad, etc.), a display screen, a network interface, software (e.g., a Web browser program, associated plug-ins, word processing programs, etc.) configured to allow a user to access and use the search tool 122 described herein, and other components.

Although the figures and descriptions below are described with regard to patent-related documents, they may apply to any system that maintains searchable and retrievable documents.

The term “patent-related documents” as used herein refers to issued patents, published patent applications, patent prosecution documents, prior art references, patent licenses, and other documents associated with one or more patents or patent applications. Patent-related documents include documents from any country or patent-issuing authority. Patent-related documents may include a plurality of fields, or categories, of information associated with the patented or patent-pending invention. For example, an issued patent document may include certain associated fields (e.g., fields for patent authority, inventor(s), title, date published, kind code, filing date, assignee, class, claims, abstract, specification, etc.). In one embodiment, patent-related documents include a “legal status” field that may include information regarding the legal status of the document (e.g., licensed, abandoned, assigned, expired, terminated, etc.). Using the legal status field, as described below, a user can query and/or track the legal status of a patent, patent application, or other patent-related document.

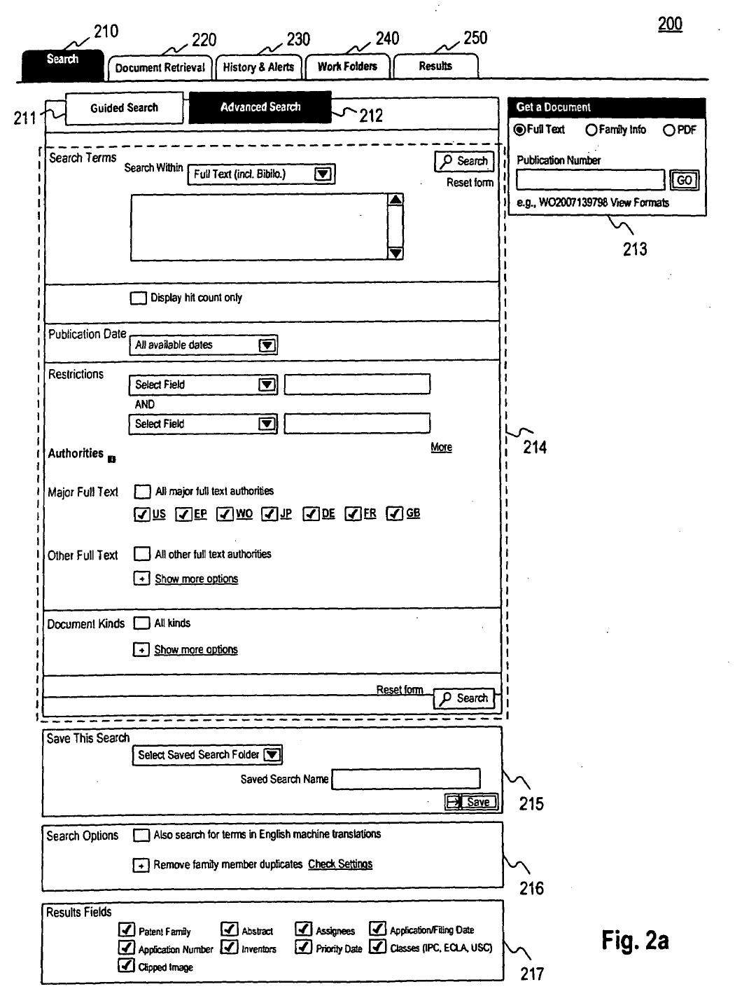

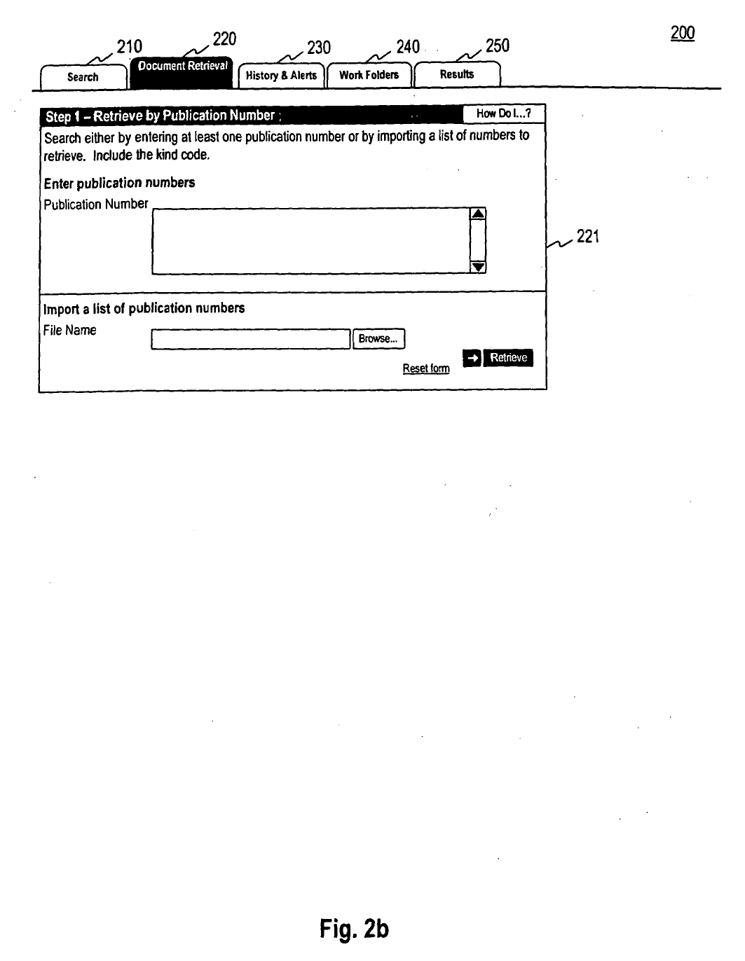

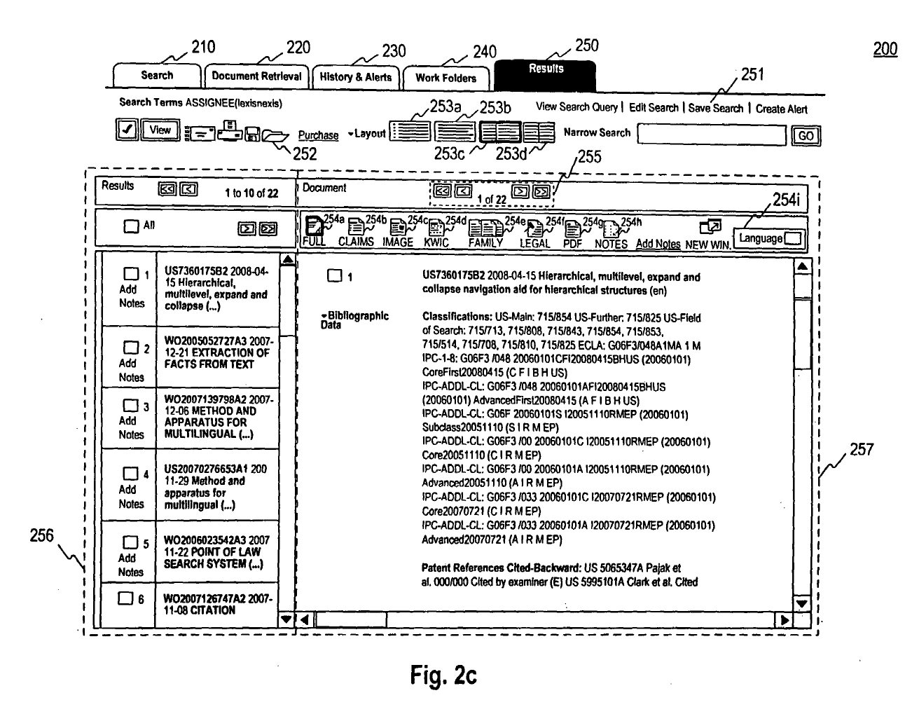

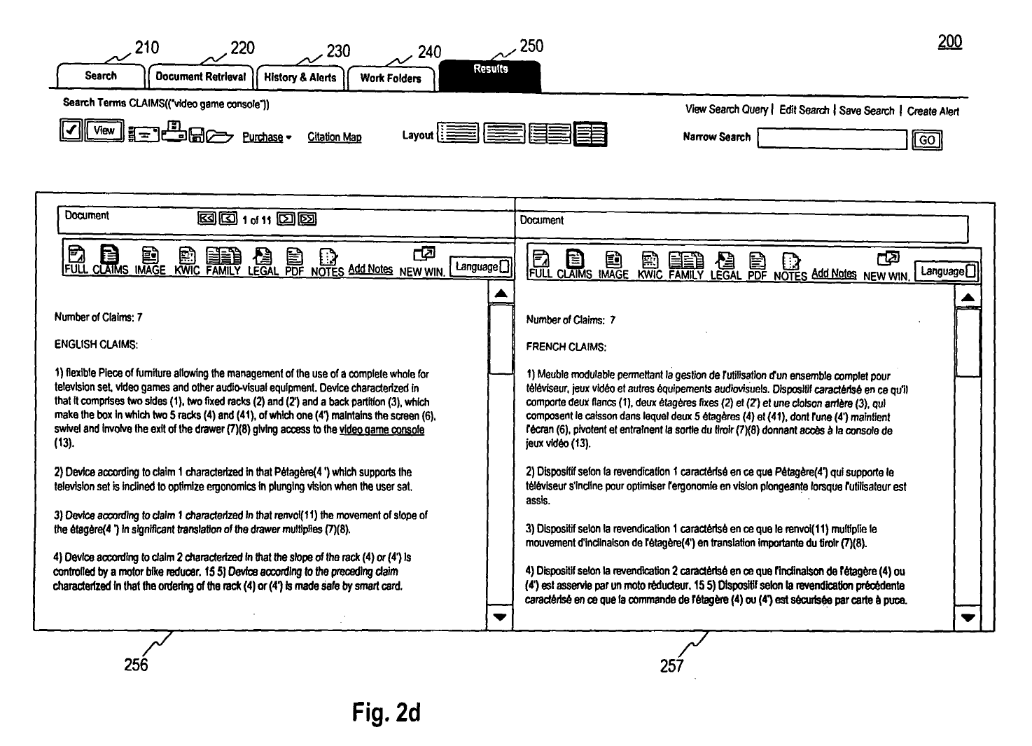

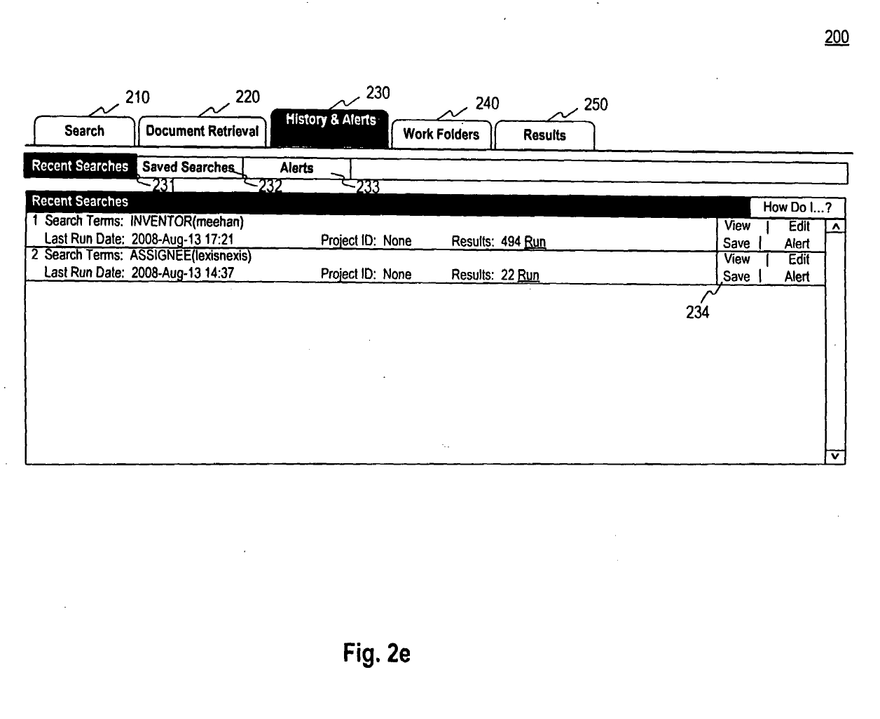

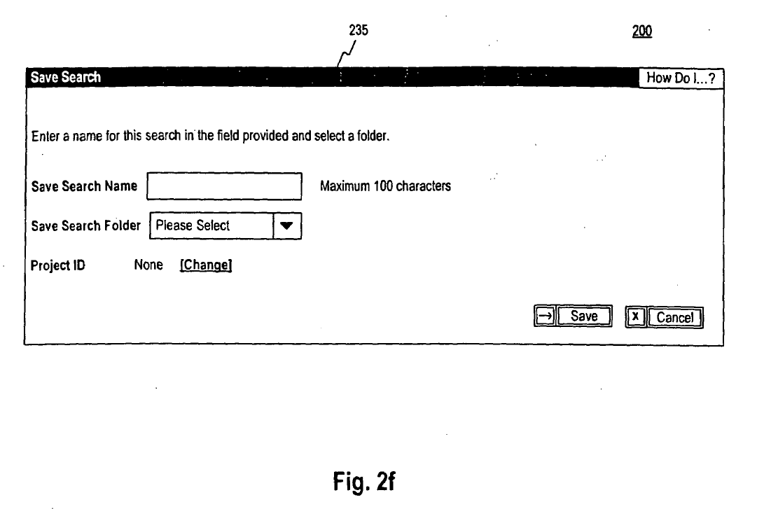

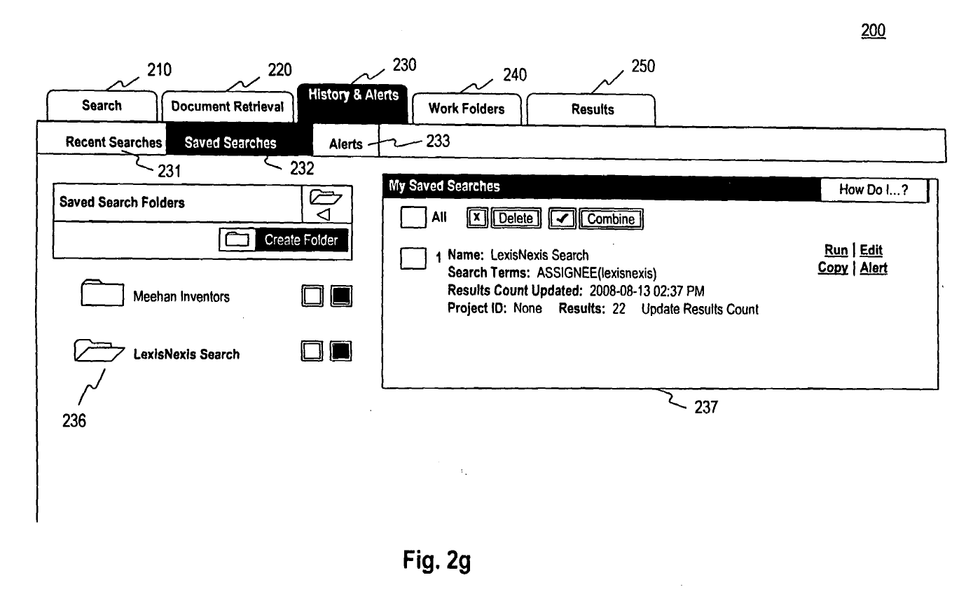

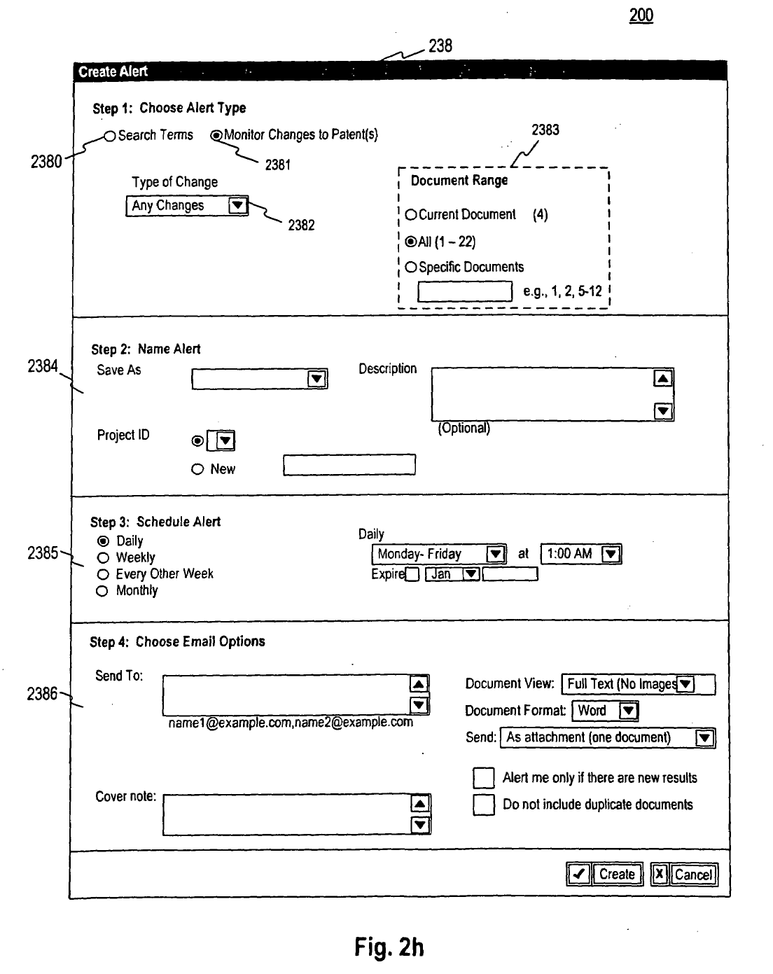

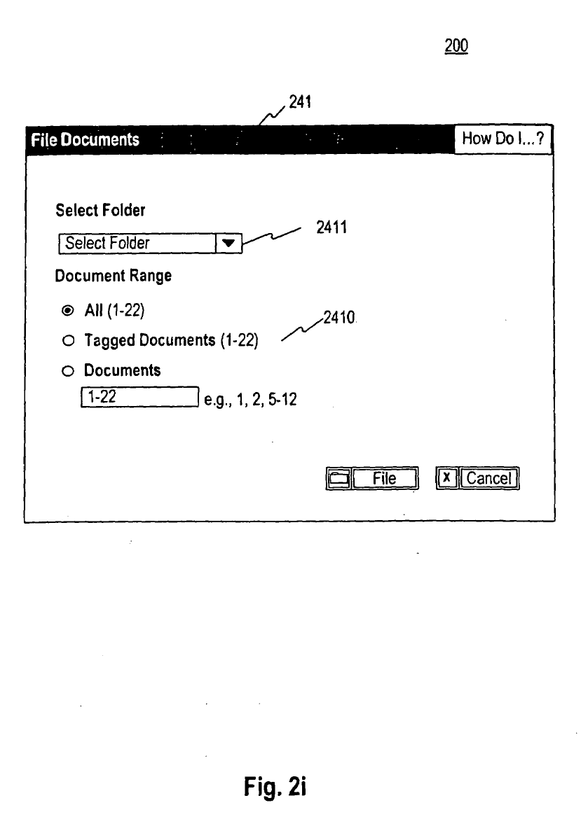

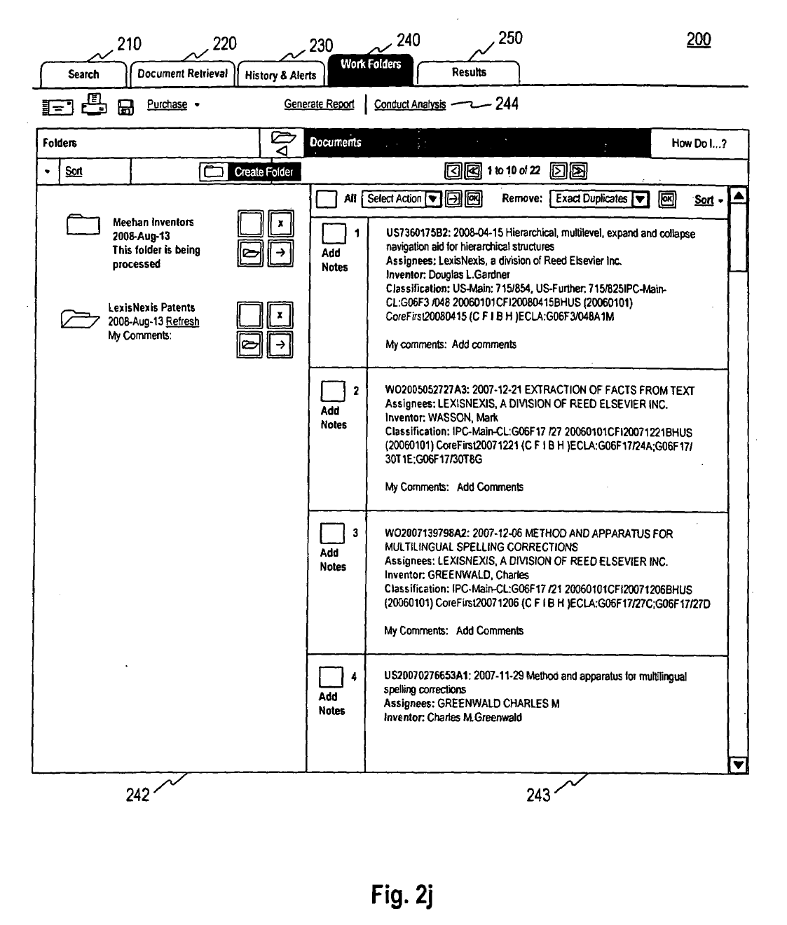

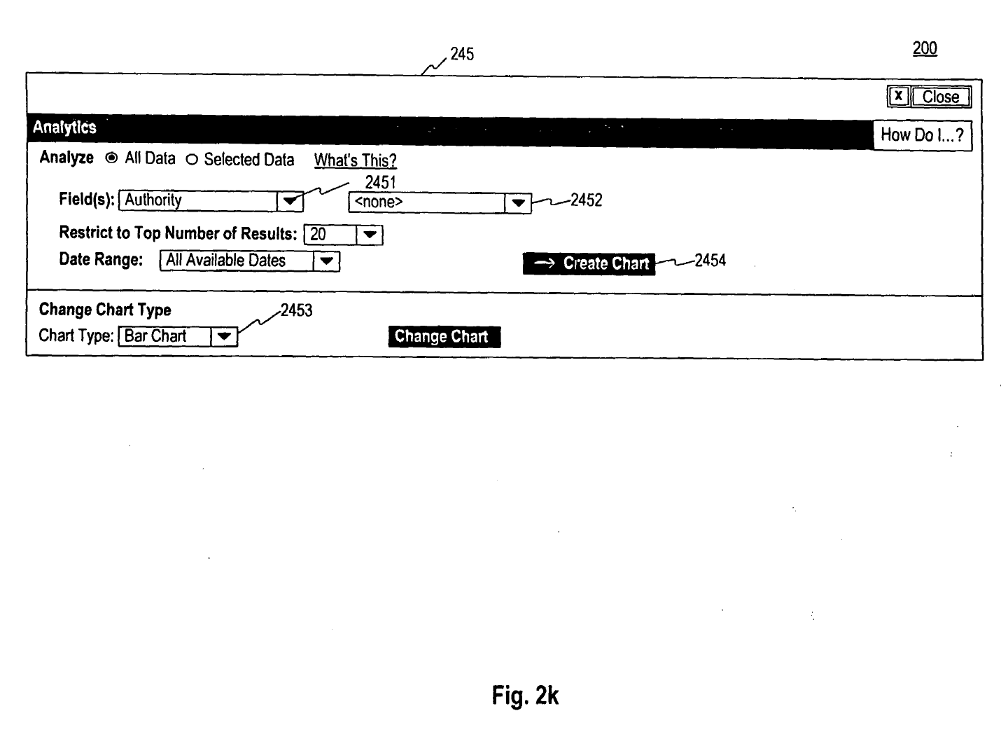

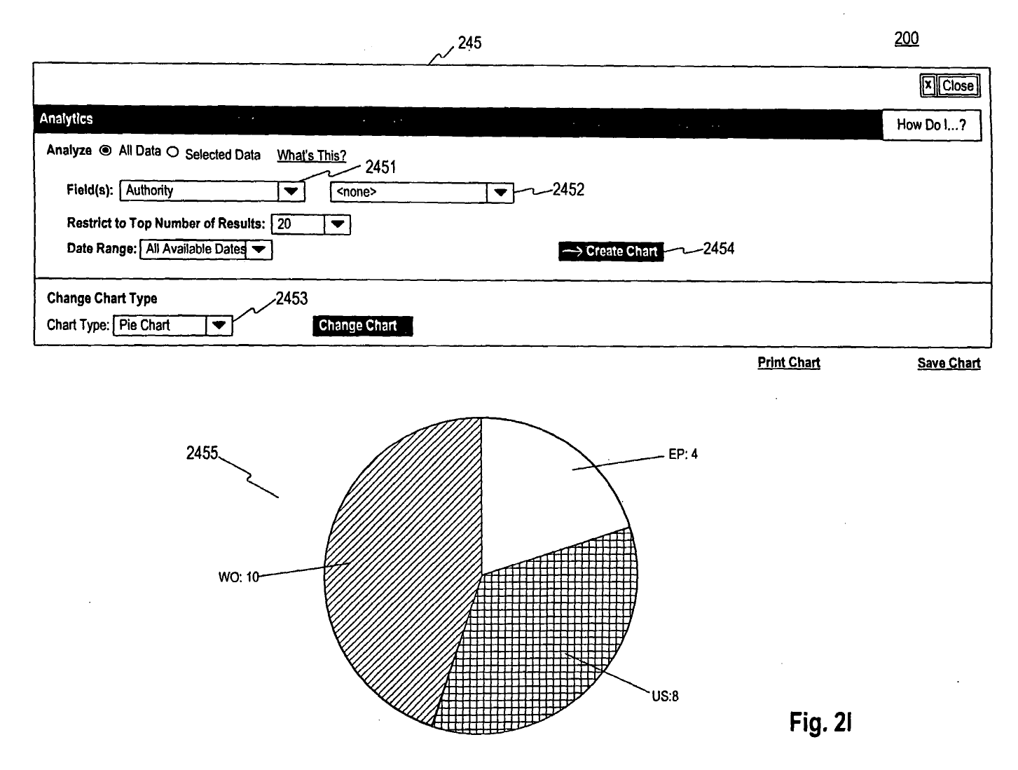

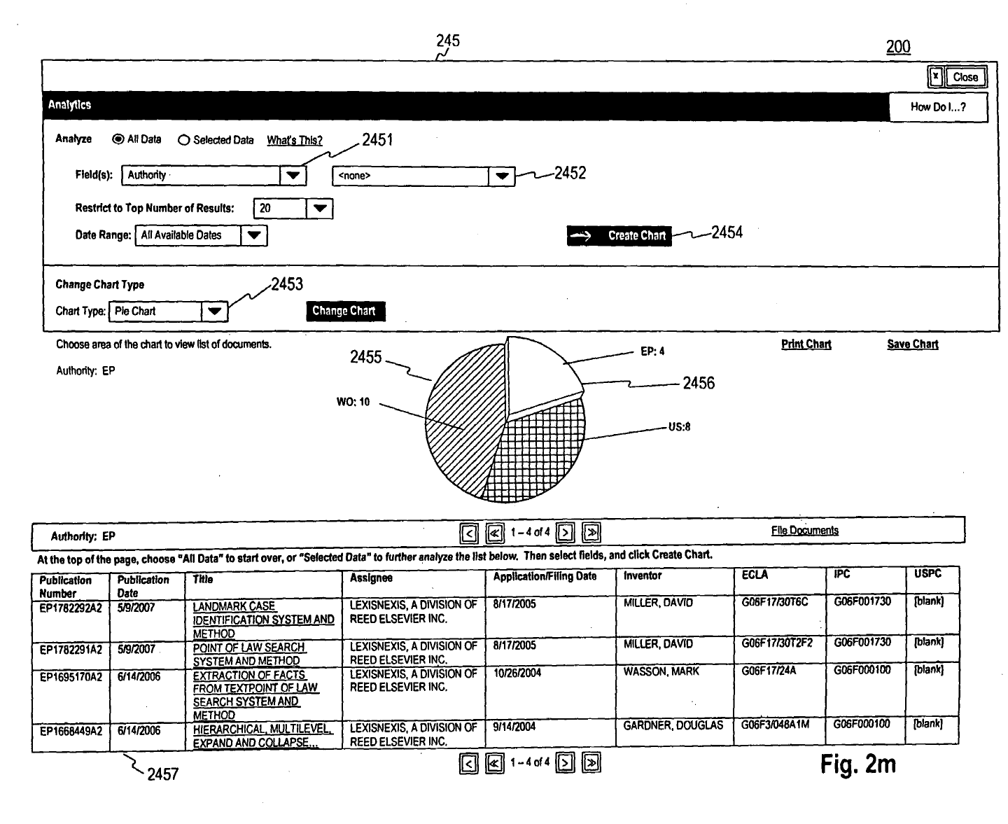

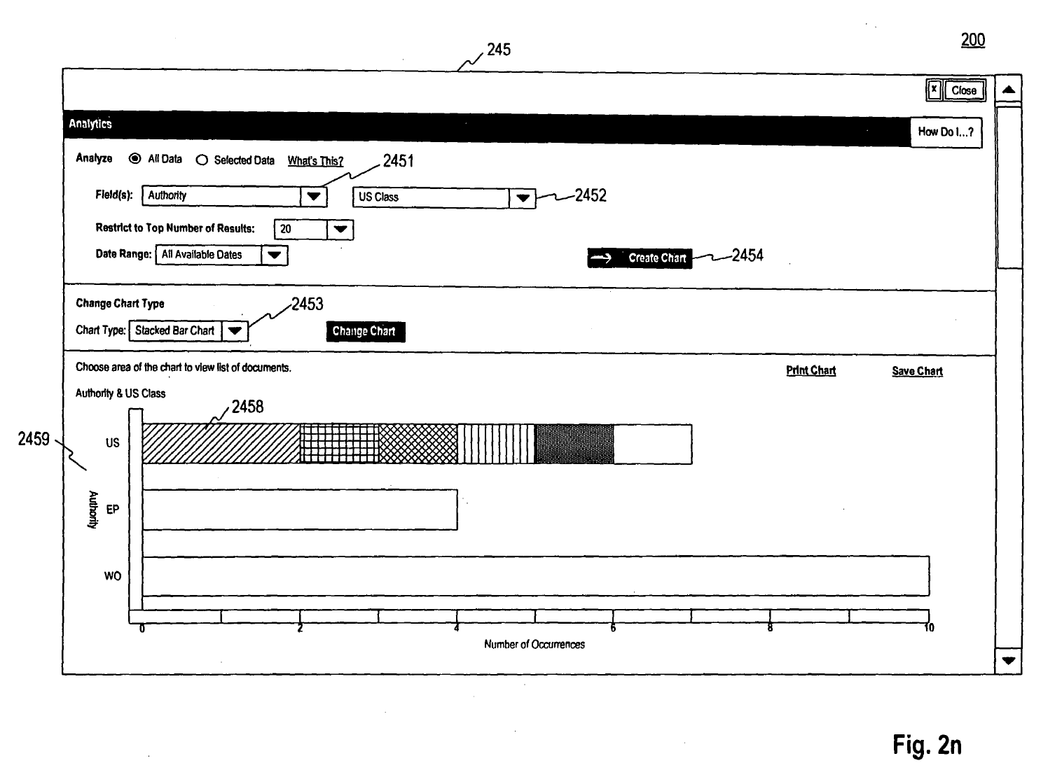

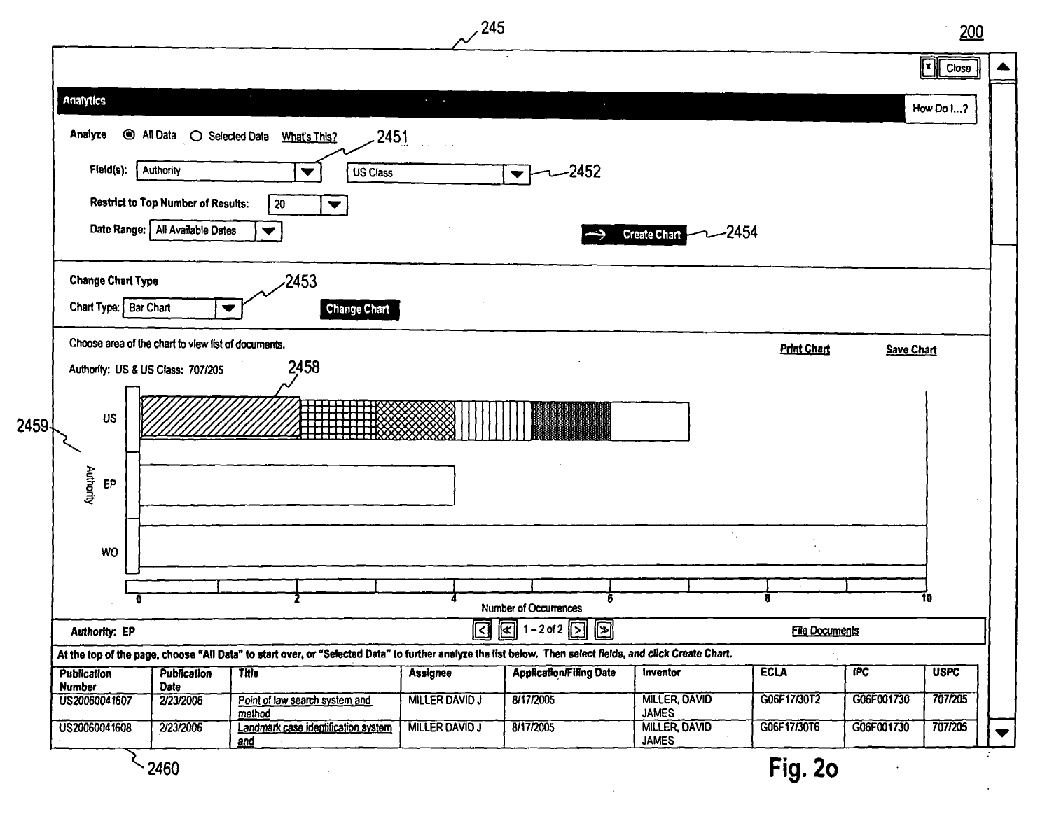

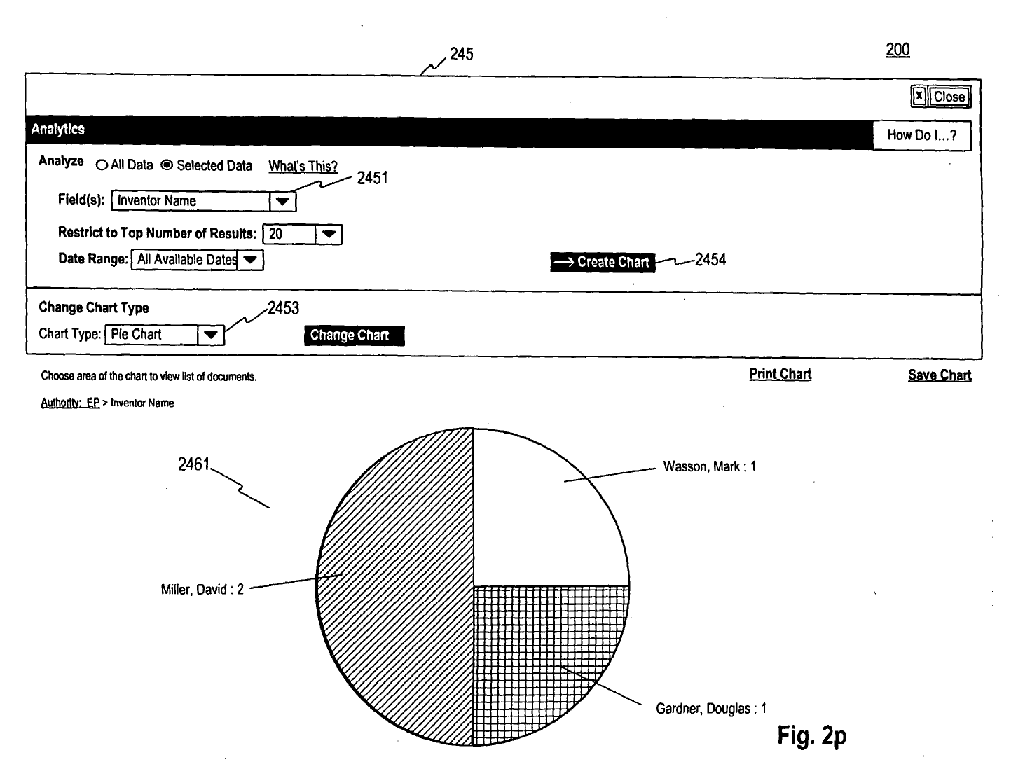

FIGS. 2a-2p depict an exemplary graphical user interface (GUI) 200 for implementing search tool 122 to search for, retrieve, and analyze patent-related documents. In one embodiment, GUI 200 may be implemented using a Web browser or other browser program, and may include a number of tabbed or otherwise separated portions that provide different functions and features. For example, in the embodiment depicted in FIG. 2a, GUI 200 includes “Search” tab 210, which provides a search interface for inputting one or more types of search queries; “Document Retrieval” tab 220, which provides a document retrieval interface for inputting information related to one or more particular documents for retrieval; “History & Alerts” tab 230, which provides an interface to access and select saved searches, and to create alerts related to patent status changes; “Work Folders” tab 240, which provides an interface that allows a user to create folders that store patent-related documents and further permits a user to perform one or more analyses on documents stored in the folders; and “Results” tab 250, which provides an interface for viewing search results. Additional features of GUI 200 and search tool 122 are described further below. Although certain features of GUI 200 and search tool 122 are described herein, the present disclosure is not limited to these features, and GUI 200 and search tool 122 may include additional features not described.

FIG. 2a illustrates an exemplary search form 212 displayed under search tab 210 for initiating a search for patent-related documents from a computer system such as one of user computer systems 130a-130n. The embodiment depicted in FIG. 2a shows an “advanced search” form 212, which permits a user to select and enter data for certain fields for a search. In another embodiment, a “guided search” form 211 may be used, which may include pre-set fields into which a user may enter data, thereby simplifying the search process for the user. As shown in FIG. 2a, advanced search form 212 includes input portions 213 and 214 for entering search query information.

Input portion 213 permits a user to search for a particular patent-related document and includes an entry box for inputting a publication number for an issued patent, published patent application, or other published patent-related document. Input portion 213 additionally includes one or more selectable objects (e.g., radio buttons) for selecting a retrieval type for the selected document (e.g., retrieve full text, family information, or PDF copy).

Input portion 214 includes one or more entry boxes and/or selectable objects (e.g., clickable links, buttons, icons, etc.; selection boxes; drop-down menus, etc.) collectively used for inputting a search query. For example, in one embodiment, input portion 214 includes a search term entry box for entering search terms, a publication date drop-down menu for narrowing a search based on a publication date, and one or more selectable drop-down menus and associated entry boxes for selecting a particular field and inputting a search term for that field with which to narrow a search. In one embodiment, the selectable drop-down menus permit a user to search for documents according to one or more fields including: inventor(s), assignee/applicant, kind code, publication country, priority data (e.g., search for all documents that claim priority to a particular patent or patent application), U.S. class, patent citation (e.g., search for all documents that cite to an inputted document, or all documents that are cited in an inputted document), European patent class, international patent class, and priority date. In other embodiments, additional fields may be searched (e.g., full text, abstract, title, etc.). Input portion 214 also includes an authorities selection portion for selecting authorities for which to search (e.g., U.S. Patent and Trademark Office, European Patent Office, Japanese Patent Office, other authorities, etc.).

In one embodiment, search form 212 additionally includes a “save this search” portion 215 including a drop-down menu and entry box that permit a user to save a search under a particular name and to a particular saved folder. Saving searches is described further in connection with FIGS. 2f and 2g below. Search form 212 may additionally include “search options” portion 216 which permits additional search features described further below, and may include “results fields” portion 217 including selection boxes that permit a user to designate the desired fields of data to be retrieved in the search and displayed to a user (e.g., patent family, abstract, assignee, application filing date, etc.). A user may use one or more of portions 214-217 to execute a search for patent-related documents. Although portions 214-217 depict certain selectable fields and entry boxes, the components shown in portions 214-217 are exemplary only. Additional, or fewer selectable objects, entry boxes, and/or text portions may be included in search form 212.

In one embodiment, a window 221 as depicted in FIG. 2b may be used to retrieve one or more particular desired documents. For example, a user may cut and paste a list of document numbers into an entry box, or may select to import a list of publications from another location in order to retrieve one or more desired documents.

FIG. 2c depicts an exemplary results window displayed under results tab 250, consistent with certain disclosed embodiments. The results window displays the results set for a search (e.g., in the example of FIG. 2c, a search for documents having the assignee “lexisnexis”), and may be displayed, for example, in response to a submitted search query, or in response to a selected recent search or re-run saved search, a selected search folder, or a selection made during an analysis, as described further below. In one embodiment, a search query may be saved by selecting a selectable object (e.g., “save search” link 251), and/or a set of documents from the search results set may be stored in a working folder by selecting a selectable object (e.g., “create folders” object 252). Saved searches and working folders will be described further below.

The results window may provide for different layouts and different view formats for a retrieved results set. For example, selectable objects (e.g., icon objects 253a-253d), may be selected to provide different layouts for a retrieved results set. In one embodiment, these layouts include a results list layout, a document view layout, a combined list and document view layout (depicted in FIG. 2c), and a dual document view layout (depicted in FIG. 2d).

For example, in one embodiment, selection of icon object 253a provides a results list layout that permits a user to view in the results window a returned results set as a list of documents. The results list may include overall result set data such as the total number of documents in the results set, and may also include document-specific data for selected fields for each document (e.g., document number, publication date, title, figures, etc.). For example, an exemplary list appears in display area 256 in FIG. 2c. In the results list layout, a list of documents (e.g., similar to that shown in display area 256) is displayed in the results window in a list or table layout. In one embodiment, each document entry in the list includes data for selected fields for that document. The selected fields may be set by default, or may be pre-selected by a user.

In one embodiment, each document entry in the list includes a selectable object (e.g., publication number or title) which when selected causes the publication to be displayed in the results window in a document view layout. The document view layout is described further below. In one embodiment, each document entry in the list additionally includes a selectable thumbnail or other image of a figure associated with the document. The image may be selected, which in one embodiment causes a pop-up window to open displaying the figure and allowing the user to scroll through one or more figures associated with the document.

Selection of button 253b provides a document view layout that permits a user to view in the results window information about each document individually. A user may navigate between documents in the results set by selecting a selectable object (e.g., arrow objects 255, a “go-to document” entry box, etc.). An exemplary document view layout may display data for a single document in the results window, with navigation buttons that permit a user to view other documents in the results set (e.g., the results window would include display area 257 without display area 256).

When viewing a document, either in document view layout, combined list and document view layout, or dual document view layout, a user can view information for each document in the search results set according to one or more pre-set view formats. In one embodiment, selectable objects (e.g., 254a-254h) may be selected to display different view formats. For example, a full text view format can be selected with object 254a, claims view format can be selected with object 254b, image view format (e.g., viewing figures of the document) can be selected with object 254c, keyword in context view (KWIC) view format can be selected with object 254d, family view format (e.g., displaying a list of all documents in the patent family) can be selected with object 254e, legal status view format (e.g., information about the legal status of the document, such as assigned, under re-examination, terminated, licensed, etc.) can be selected with object 254f, PDF view format (e.g., pdf copy of the document) can be selected with object 254g, and a notes view format (e.g., view notes that the user or others have added to the document) can be selected with object 254h. In addition, drop-down menu 254i may be selected to change the language displayed for the text portion of the patent, if a translation is available. For example, as described further below, FIG. 2d depicts a selected claim view format where two different languages for the claims of a document are displayed simultaneously in two different display areas.

Selection of button 253c provides a combined list and document view layout that simultaneously includes a results list (e.g., as shown in display area 256) and a document view (e.g., as shown in display area 257). In the embodiment shown in FIG. 2c, the combined list and document view layout has been selected. In one embodiment, each document entry in the list may include a clickable link that, when selected, causes that document to be displayed in display area 257. In this way, a user can easily navigate between viewing different listed documents in the results set. In addition, or alternatively, a user may navigate between documents in the results set by selecting arrow objects 255 or other selection objects.

In a further embodiment, selection of button 353d provides a dual document view layout that displays a document view of a document for the results set in display area 256 and a second document view for the same document in display area 257. In this way, a user can view different view formats of a document in two windows simultaneously. In one embodiment of the dual document view, as depicted for example in FIG. 2d, each of display areas 256 and 257 displays a set of selectable objects such as objects 254a-254h, as well as a language drop-down menu 254i. A user may select for each display area a desired view format and a desired language. Thus, for example, a user may view the claims of a patent or published application in display area 256 while viewing the images for the patent or published application in display area 257. Similarly, as further depicted in FIG. 2d, a user may view a particular view format of the document in display area 256, and may view the same view format, but in a different language, in display area 257. In one embodiment of the dual document view layout, when a user navigates to a different document (e.g., by selecting arrow objects), the previously selected view formats persist such that both display area 256 and display area 257 of the dual document view display the newly selected document using the same view format that was displayed for the previously selected document.

In one embodiment, a user may use search tool 122 to search for documents that have been published in foreign languages. For example, central computer system 120 may store data for documents published in English (e.g., retrieved from authorities such as the USPTO) and may also store data that includes additional translation information for documents published in a different language (e.g., retrieved from the French, German, or other authorities). In one embodiment, central computer system 120 stores both foreign language text and translated English text for foreign language documents. In this embodiment, the user may select an option (e.g., via a selection box such as shown in portion 216 of FIG. 2a), such that when the user enters a search query in English, search tool 122 searches for the query terms in documents natively in English, in documents natively in foreign languages, and also in the stored translations for the documents natively in the foreign languages. The stored translations may have been translated by central computer system 120 as machine translations, or may have been translated by some other party.

In response to the search query, search tool 122 retrieves a results set that includes both English language documents and foreign language documents and their translations. In one embodiment, the information retrieved and displayed to the user for foreign language documents includes document information in its native language, and certain translated document information (e.g., claims, abstract, specification, and title). In one embodiment, as depicted in FIG. 2d, in dual document view layout a user can select a language for each display area 256 and 257 using a selectable object (e.g., language drop-down menu 254, which may provide a selection of one or more languages available for display). As a result, one display area can display the English translation while the other simultaneously displays a foreign language for the same portions of the same document. As such, both languages would be displayed in the same browser window at the same time. In an alternative embodiment, both the native language and the English translation may be combined to appear in the same display area (e.g., in either display area 256 or display area 257), for example, by displaying the translated-to-English abstract, followed by the foreign abstract, followed by the translated-to-English specification, followed by the foreign specification, etc. In either embodiment described above, the search query terms may be highlighted (e.g., underlined, in bold, a different color, etc.) in the translated portion of the displayed document so that the user may determine where in context the same term appears in the native document.

In one embodiment, when formulating a search query, the user may select an option to remove duplicates from retrieved search results. For example, as shown in FIG. 2a, a user may select a selectable object (e.g., a selection box as shown in portion 216 of search form 212) that causes search tool 122 to remove patent family member duplicates from the search results set. Patent family member duplicate documents may includes, for example, a set of documents having essentially the same specification, but filed in different languages with different patent authorities. Patent family member duplicate documents may also include, for example, a set of documents which claim priority to/from each other. If the user selects to remove patent family member duplicates, search tool 122 removes duplicate family documents retrieved from the search, such that only one document from the family is returned to GUI 200 and included in the results displayed to the user at one of user computer systems 130a-130n. Removing these duplicates reduces the amount of information transferred to the user and reduces the amount of duplicate documents displayed to the user.

In one embodiment, duplicates are removed based on one or more criteria. For example, duplicates may be removed such that the remaining document is selected based on a user-selected or automatically selected preferred authority (e.g., USPTO, EPO, JPO, etc.), an earliest publication date among the family, an earliest application date among the family, etc. For example a user may select U.S. authority as a default authority such that if central computer system 120 retrieves in response to a search two U.S. patents and one European patent that are all members of the same patent family, only the oldest-filed U.S. patent is included in the results set displayed at a user computer. As such, duplicate family document information may be removed from the results set before the results set is returned or displayed to the user.

FIGS. 2e-2h illustrate an exemplary history & alerts tab 230 associated with GUI 200 that permits a user to review and save prior searches, and to set alerts to notify the user of status updates of one or more patent-related documents.

In one embodiment, search tool 122 permits a user to view recent searches and to save selected searches to a saved search folder. For example, when a user first selects history & alerts tab 230, a history and alerts window such as depicted in FIG. 2e may be displayed. In one embodiment, the history and alerts window provides three sub-windows: recent searches sub-window 231, saved searches sub-window 232, and alerts sub-window 233.

Recent searches sub-window 231 may display a list of recent searches performed by a user. In one embodiment, each entry in the list remains in the list for a set period of time (e.g., 24 hours, 2 days, etc.) and the user cannot remove entries from the list. For each listed search, recent searches sub-window 231 provides selectable objects 234 which permit the user to view the search results of the search, save the search in a search folder (described below), edit the search and run a new search (in which case the old search remains listed in the recent searches window and the new search is also listed in the recent searches window), or set an alert for the search results.

In one embodiment, a user may select to save a search, for example, by selecting a “save” link associated with the search as depicted in FIG. 2e. A user may also save a search by selecting a similar selectable object from a results window, such as depicted in FIGS. 2c and 2d (e.g., “save search” link). In one embodiment, when a user selects to save a search, a save search window 235 such as depicted in FIG. 2f is displayed. Save search window 235 permits a user to select a name for the search and a folder for which to save the search. In one embodiment, one or more searches can be saved to a single search folder.

Saved searches sub-window 232, as depicted in FIG. 2g, provides the user with a list of searches that have been permanently saved. In one embodiment, a user may be permitted to save up to a maximum number of searches (e.g., 100, 150, etc.). As depicted in FIG. 2g, saved searches sub-window 232 may include a list portion 236 and details portion 237. For example, list portion 236 may include a list of the search folders that have been created by the user. As depicted in FIG. 2g, the user has created a “Meehan Inventors” folder and a “LexisNexis Search” folder. If the user then selects one of the folders displayed in list portion 236, the details for that folder appear in details portion 237. Details portion 237 may include, for example, a list of all of the searches saved to the selected search folder, and for each saved search, a description of a search name, the search terms, the search time, a results count, and other information. The user may additionally select from details portion 237 to run a saved search, to edit a saved search, to copy a saved search, or to set an alert for the saved search.

If the user selects to run the search or to edit the search and run a new search, an updated search may be performed. The updated search will be added to the list of recent searches in recent searches sub-window 231.

In one embodiment, either from the recent searches sub-window 231, the saved searches sub-window 232, or a search results window (e.g., shown in FIG. 2c or 2d), a user may select a selectable object (e.g., an “alert” link) to create an alert, which causes a create alert window 238, such as depicted in FIG. 2h, to be displayed. Alerts provide the user with automatic updates on a periodic basis of the status of one or more patent-related documents.

One type of alert, which may be created using a create alert window 238 is a search terms alert 2380. General search terms alerts are typically used to automatically re-run a search and to notify a user of new documents that are retrieved in the updated search results.

Another type of alert, which may be created using the create alert window 238, is a monitor alert 2381, which monitors changes to the status of one or more patent-related documents. The monitor alert 2381 permits a user to select one or more specific issued patents, published patent applications, or other patent-related documents to monitor, so that the user may be automatically informed of important changes in the status of those documents. As described below, monitor alerts may be issued in various manners and at user-selected intervals, and may monitor one or more status changes to a selected document set.

As depicted in FIG. 2h, a user may create an alert to monitor the status of one or more changes to one or more documents. The user may select the documents to monitor, the types of changes to monitor, the time period and frequency for receiving the alerts, and a manner of receiving the alerts.

For example, in one embodiment, the user may use selectable objects 2383 to select a document set including one or more documents to include in the alert. For example, in FIG. 2h, a user has selected a document range of “All (1-22).” The document numbers (e.g., “4” and “1-22”) depicted in FIG. 2h refer to numbered documents from a search results set (e.g., the “ASSIGNEE(lexisnexis)” depicted in FIGS. 2c, 2e, and 2g).

A user may use selectable object 2382 to select one or more types of changes to monitor for the selected document set. In one embodiment, these changes may be designated according to fields or types of information and may include legal status changes, citing information status changes, new family information changes, assignee status changes, new kind code status changes, or classification status changes. The user may also select to monitor all status changes for the selected document set.

In one embodiment, a user may monitor legal status changes, which indicate new legal transactions, filings, encumbrances, and the like for the documents in the selected document set (e.g., filing of a lawsuit involving any of the patents in the document set, filing of a re-exam request for any of the patents in the document set, creating a new assignment for any of the patents or published patent applications in the document set, creating a security interest in any of the selected patents or published patent applications in the document set, entering into a license for any of the patents or published patent applications in the document set, etc.). To keep track of legal status changes, central computer system 120 may store an updated record for each document in the selected alert document set of all legal status change information for the document. In addition, central computer system 120 may also store records for determining whether the legal status has changed since the last scheduled legal status update check was executed for a user or for a project associated with the user.

For example, the system may store a first time stamp indicating the most recent time that the legal status of the document changed, and a second time stamp specific to a particular user or project indicating the most recent previous time that a legal status update check for that user or project was executed. The system may then compare the time stamps. If the first time stamp indicates a later time than the second time stamp, then a change in legal status for the document has occurred for that user/project, and an alert message may be sent. The time stamps may be compared, for example, each time a scheduled legal status update check is executed for a user or project.

The user may additionally or alternatively monitor citing information status changes associated with a patent-related document. Citing information status includes, for example, all documents that cite the selected patent-related document, or all documents cited in the selected patent-related document. For example, a patent may issue that cites a number of “prior art” documents (herein referred to as “backward-cited documents”). A set of identification data for all backward-cited documents for a patent may be stored, for example, on central computer system 120, and may be included in a backward-citation field associated with the patent. In addition, an issued patent may be cited in later patents, search reports, or other patent-related documents (hereinafter referred to as “forward-cited documents”). A set of identification data for all forward-cited documents for a patent may also be stored, for example, on central computer system 120, and may be included in a forward-citation field associated with the patent.

To keep track of citing information status changes, central computer system 120 may keep an updated record for all forward-cited documents associated with a patent-related document, and may keep an updated record for all backward-cited documents associated with the patent-related document. In one embodiment, these records may be maintained as separate data sets. In addition, central computer system 120 may also store records for determining whether the records for forward-cited and backward-cited documents have changed since the last scheduled citation status update check was executed for a user or for a project associated with the user.

For example, the system may store a first time stamp indicating the most recent time that the forward citation information for the document changed, and a second time stamp specific to a particular user or project indicating the most recent previous time that a forward citation status update check for that user or project was executed. The system may then compare the time stamps. If the first time stamp indicates a later time than the second time stamp, then a change in forward citation status for the document has occurred for that user/project, and an alert message may be sent. The time stamps may be compared, for example, each time a scheduled forward citation status update check is executed for a user or project. A similar procedure may be used to detect changes to backward-citation status.

Similar records to those described above can be maintained for kind codes, new patent family documents, assignee of record, and classification status, and similar comparisons may be made in order to determine whether the status of those fields has changed.

In addition to selecting the documents and types of changes to monitor in an alert, the user may name the alert, and describe the alert (e.g., using input portion 2384). The user may select a schedule for the alert (e.g., using input portion 2385) by designating how often to run status update checks (e.g., daily, weekly, monthly, etc.), when to run the status update checks during the selected time period (e.g., Monday-Friday at 1:00 A.M.), and when the alert expires. The user may further select how to receive the alert (e.g., using input portion 2386) by designating an e-mail address or other address to which to send the alert, designating a cover note for the alert, and selecting a format for delivery (e.g., full text, front page, KWIC, PDF Image, etc.). The cover note may be prepared by the user to describe the alert. In one embodiment, by default, the user may receive an alert message every time a status update check is run. However, in one embodiment, the user may additionally select an option to be alerted only if there are new results (e.g., only when status for one or more of the selected fields of the document have changed).

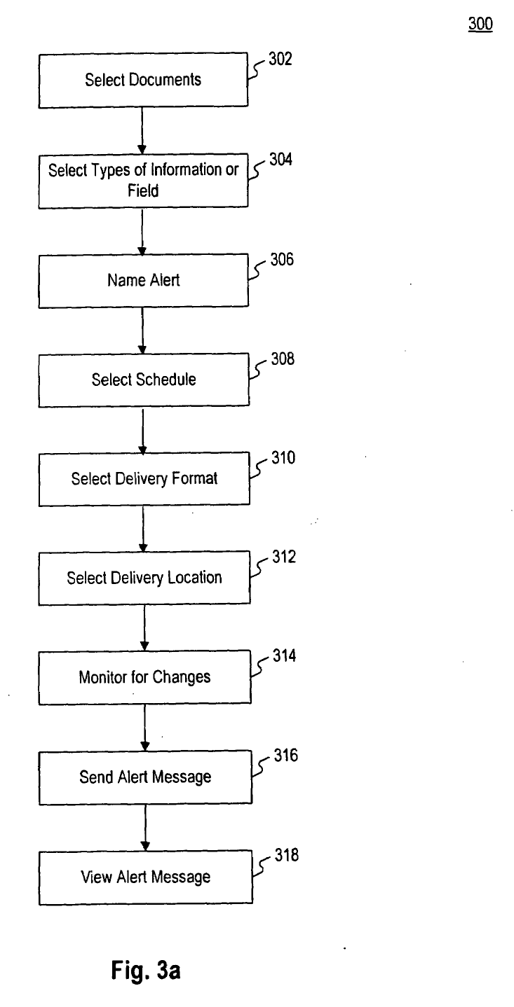

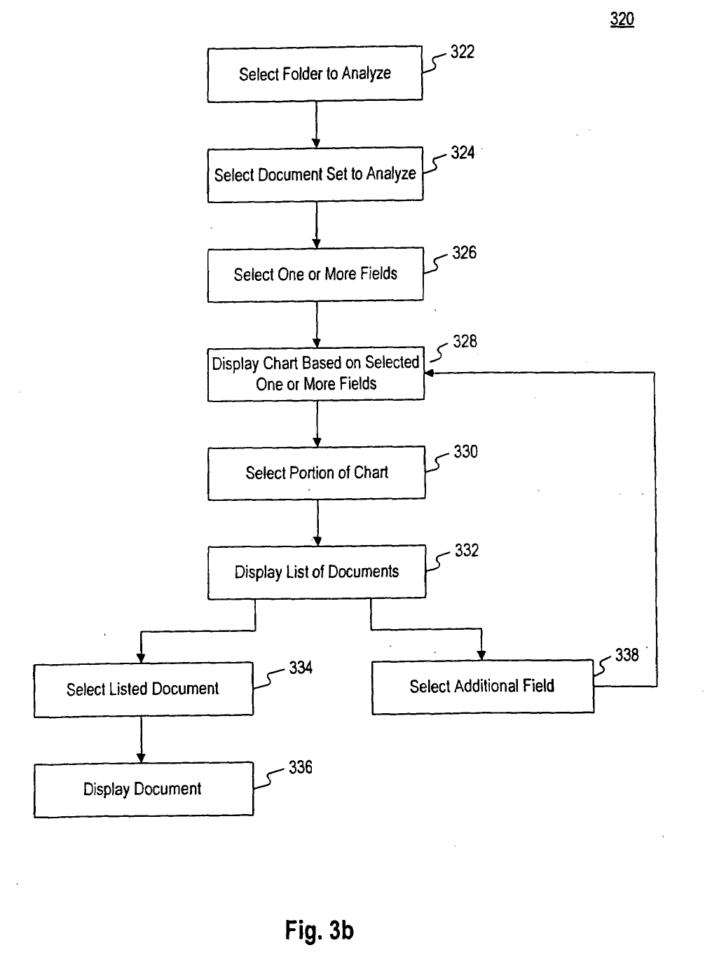

An exemplary method 300 of creating and receiving alerts is depicted in FIG. 3a. In operation, to create an alert, a user selects the documents to be monitored (step 302), selects the types of information or fields to be monitored (step 304), names the alert (step 306), selects a schedule for checking for updates and for being alerted of the updates (step 308), selects a format for delivery (step 310), and selects a delivery location (e.g., e-mail address or other address) and optional cover note to be included in the alert (step 312). Steps 302-312 may occur in any order, and need not all be selected by a user. For example, certain of steps 302-312 may be automatically set or set to a default value. In response to the user creating the alert (e.g., after the user selects a “create” button, which transmits the alert instructions to central computer system 120), central computer system 120 monitors its stored records for updated statuses of the selected documents and selected types of information or fields according to the selected schedule (step 314). If the status of the selected type of information or field for a selected document has been updated, the central computer system 120 sends a message to the designated delivery location (e.g., sends an e-mail to a designated recipient) with a copy of the document or part of the document in the selected delivery format, and with a cover note that may indicate the type of status change for the alert (step 316). By receiving the message, the user is made aware that the status of the document has changed. The user may then view the message (step 318). For example, a user may receive an e-mail with a note that states “This patent has a new legal status,” and with an attachment of the selected patent in a full-text format that includes a field including a description of the new legal status. In one embodiment, a plurality of alerts for the same document may be created (e.g., to monitor the citation status separately from the legal status, etc.).

In one embodiment, after one or more alerts have been created, the user may view the created alerts by selecting alerts tab 233 under history & alerts tab 230 (e.g., shown in FIG. 2g). In response, a sub-window under alerts tab 233 may be displayed (not shown). In one embodiment, the alerts sub-window displays a list of alerts that have been created, as well as selection objects for each alert that permit a user to delete the alert, pause the alert, or resume the alert. As such, the user may temporarily or permanently turn alerts on or off. Alerts sub-window may additionally include for each saved alert a selectable object the permits the user to select an alert to be run on demand (e.g., without waiting for the next scheduled alert). Thus, upon such selection, in one embodiment, if any updates to the status of the selected field exist, the user will be immediately sent a responsive alert message.

In one embodiment, search tool 122 permits users to create work folders for storing sets of documents, and further permits the user to store selected documents in the work folder. These documents may be later accessed and/or analyzed without the user needing to run or update a search. In one embodiment, for each work folder, the work folder is created, documents are selected and stored in the work folder, and then documents may be viewed from the work folder and/or and analysis of the documents in the work folder may be performed.

Work folders may be created, for example, either from a results window or from Work Folders tab 240. In one embodiment, to create a work folder, a user viewing a results set in a results window selects the create folders object 252 (e.g., depicted in FIGS. 2c and 2d). In response, a create folder window 241 is displayed, as depicted in FIG. 2i, which permits the user to create a new folder and select documents to place in the folder. Create folder window 241 may include, for example, selectable document range objects 2410, which permit a user to select the range of objects to include in the folder (e.g., all objects in the results set, a set of tagged documents from the results set as tagged in the results window, or a selected set of documents. Create folder window 241 may additionally include a select folder drop-down menu 2411, which permits a user to select an existing folder to which to save the documents or create a new folder to which to save the documents. After the user selects the documents and the folder, the user may select a “file” button or the like, which instructs central computer system 120 to save the selected documents to the selected folder. In an alternate embodiment, a user may create a new work folder, without saving any documents to the folder, by selecting a “create folder” button in a work folders window displayed under work folders tab 240.

After one or more work folders have been created, a user may view the work folders in a work folders window, such as depicted in FIG. 2j. FIG. 2j displays a set of created work folders in display area 242, and displays a list of the documents saved to a selected work folder in display area 243. For example, as depicted in FIG. 2j, work folders “Meehan Inventors” and “LexisNexis Patents” have been created and are displayed in display area 242. In addition, the “LexisNexis Patents” folder has been selected, so a list of documents saved to that folder are displayed in display area 243. A user may navigate the list using a scroll bar and/or using navigation arrows. In addition, the user may select one of the documents to view via a selectable object associated with that document (e.g., a text link displayed in the list). In response, the document may be displayed in a pop-up window or other window (e.g., a pop-up results window displaying a document view layout for the document).

In one embodiment, work folders may include a large number of documents (e.g., hundreds, or thousands). Thus, in order to permit a user to easily navigate among and differentiate between documents stored in a work folder, an analytics tool is provided. The analytics tool may be integrated within search tool 122 and may be made available through part of GUI 200 such that a user need not separately import documents from a work folder in one software program to an analysis tool in a different software program. Instead, the user may select documents saved in the work folder (e.g., by selecting boxes in display area 243), and then select a “conduct analysis” button 244 or other similar selectable object, which causes an analytics window 245 to be displayed, as shown, for exmaple, in FIG. 2k.

Analytics window 245 permits a user to graphically analyze selected documents from a work folder, based on selected fields or categories. As such, analytics tool serves as a visual aid to assist a user in reviewing and filtering through a particular set of documents. For example, a user may have performed a search for patents owned by a particular assignee and saved the results in a work folder. In certain situations, the work folder could include thousands of documents, which may be difficult to search through. In some situations, a user may not know exactly which documents in the work folder to search for, or which are most relevant for the user's needs.

By using the analytics tool disclosed herein, the user can easily determine and view which documents in a document set have certain characteristics that the user may not have recognized prior to creating the document set. Thus, the user may recognize trends or patterns in a set of patent documents (e.g., popular classes, relevant law firms, prolific examiners) that the user was unaware of and which may be useful for analyzing the set of patent documents. For example, as depicted in FIG. 2k, the user can select to view a sub-categorization of the documents based on or more fields (e.g., by selecting a field from drop-down menus 2451 and/or 2452). These fields may include, for example, authority, kind code, assignee name, inventor name, first published date, priority date, application date, granted date, U.S. class, International Class, European class, most recent legal status, attorney/agent, examiner, etc. The user may also select a type of chart (e.g., bar chart, pie chart, etc., if only one field was selected, or stacked bar chart, bubble chart, or the like, if two fields were selected) using, for example, chart type drop-down menu 2453. The user may then select to create the chart (e.g., by selecting “create chart” button 2454).

As a result, analytics tool presents the user with a graphical image (e.g., pie chart, bar chart, or other graphical image) that graphically depicts the sub-categories for the documents for the selected field. In one embodiment, for example, where one field is selected, the tool may present the user with a pie chart, such as depicted in FIG. 21. The chart in FIG. 21 depicts an example where a user selected to view the “authority” field. Therefore, pie chart 2455 shows sub-categories of the authority field, which may include the different authorities (e.g., U.S., EP, WO, etc.) associated with the set of documents. The chart may also indicate the number/percentage of documents common to each sub-category. For example, pie chart 2455 indicates the number/percentage of the documents published by a first authority (e.g., U.S.), the number/percentage published by the a second authority (e.g., EP), and the number/percentage published by the a third authority (e.g., WO). In one embodiment, each portion of the chart also includes an associated textual description that describes, for example, the associated sub-category and the number of documents in that sub-category (e.g., “WO: 10,” “EP: 4,” and “US: 8”). In another embodiment, when a user places a pointer over the graphical portion or associated textual description for a particular sub-category, pop-up text or graphics is displayed that further describes the documents in that sub-category (e.g., a percentage may be displayed, or an unabbreviated authority code may be displayed, such as “United States,” “Europe,” etc.).

In an embodiment where two fields are selected from analytics window 245 shown in FIG. 2k, a stacked bar chart 2459, or other two-dimensional chart may be displayed, such as depicted in FIG. 2n. As shown in FIG. 2n, a user has selected to view the documents in a folder according to both authority and U.S. Class. As a result, a stacked bar chart 2459 is displayed. Stacked bar chart 2459 shows sub-categories for both fields of information. For example, it shows three bars depicting sub-categories for the authority field, each bar displaying the number of documents published by a particular authority. In addition, stacked bar chart 2459 shows, for each particular authority (e.g., each displayed bar) a further sub-categorization of the documents according to U.S. Class. In the embodiment disclosed in FIG. 2n, when a user places the pointer over a portion of the bars, a pop-up text or image is displayed, showing the selected authority and the U.S. Class associated with that portion of the bar, and the number of documents associated with that portion of the bar. Therefore, if the user scrolls over portion 2458 of the U.S. bar, pop-up text may be displayed that indicates, for example, “U.S. Authority,” “U.S. Class 707/205,” and “2 documents.”

To further aid the user, the portions of graphical images in the chart (e.g., a slice of a pie chart, a bar in a bar chart, etc.) and/or their associated textual description may be selected by a user (e.g., by clicking with a mouse or other input device) in order to display further information. Thus, in one embodiment, if a user selects one of the graphical portions of the chart or its associated textual description (e.g., the “EP 4” portion of pie chart 2455 or the text “EP 4” in FIG. 21, or portion 2458 of stacked bar chart 2459 in FIG. 2n), a selectable list of the documents represented by that portion of the chart may be displayed. Exemplary lists 2457 and 2460 are shown in FIGS. 2m and 2o in which the user has selected to view a graphically-depicted portion of documents from the selected folder. A user may then select one of the listed documents to view the entire document (e.g., in a document view format). In one embodiment, the selected portion of the chart may be highlighted (e.g., outlined, have a 3-dimensional appearance, etc., depicted in portions 2456 and 2458 in FIGS. 2m and 2o) to graphically depict the document set selected and displayed in the list.

In a further embodiment, after the user selects a portion of the chart to display a list, the user may then further categorize the documents in the displayed list by selecting another field. For example, when a chart such as depicted in FIG. 21 is displayed, the user may select the “selected data” radio button and then input a further field with which to filter the documents. As a result, a more focused chart may be displayed. For example, in FIG. 2p, a user has selected a portion of the chart in FIG. 21, and has then selected the “selected data” button and an additional field of “inventor name.” As a result, a more focused chart 2461 is displayed, which categorizes documents from the folder that have the authority U.S. into sub-categories, according to inventor name. As such, the user can easily drill-down from a large set of documents to locate a more focused set of desired documents.

The drill-down feature may be used either in the one-dimensional chart, or for the two-dimensional chart for any selected document sub-set. In addition, the user can continue to drill down to select more further focused document sub-sets according to additional fields and sub-categories. For example, for a set of 1000 documents, a user may first categorize the 1000 documents according to a first selected field (e.g., authority) and view a chart of the sub-categories associated with that field. The user may then select a portion of the graphical representation in the displayed chart (e.g., the U.S. authority portion) to view a list of documents having information common to the sub-category associated with that portion (e.g., having U.S. as the authority). However, the number of listed documents may still be high (e.g., 500). Therefore, to reduce the number of documents in the list, the user may select another field (e.g., U.S. class) to view a second chart of the U.S. authority documents from the folder, categorized according to U.S. Class. Within that second chart, the user may select a portion of the chart (e.g., a particular class), and may further drill down within that selected portion to categorize U.S. authority documents having a particular U.S. class according to yet another field (e.g., inventor name). This process may continue until the user has arrived at a desired sub-set of listed documents.

FIG. 3b illustrates an exemplary method 320 for using the drill-down analysis procedure with the search tool 122 and GUI 200 described above. In step 322, a user selects a work folder to analyze. In step 324, the user selects a document set from the work folder to analyze. In step 326, the user selects one or more fields to analyze for the selected document set. In step 328, GUI 200 displays a graphical image (e.g., a chart) based on the selected one or more fields. For example, for a selected field, central computer system 120 may determine the sub-categories associated with the selected document set for the selected field, such that GUI 200 displays a chart showing the sub-categories, and indicating the number of documents that are common to each sub-category. In step 330, a user selects a portion of the chart that represents a sub-set of documents common to the sub-category represented by the selected portion. The user may alternatively select textual information associated with the portion. In step 332, in response to the user's selection, a list of documents in the selected sub-category are displayed. In step 334, the user selects one of the listed documents, such that the document is displayed (step 336). Alternatively, or additionally, the user may select an additional field (step 338), such that a new chart is displayed that represents documents matching the originally selected sub-category, further categorized based on the selected additional field. In this manner, the user may continue to drill-down to focus the search for desired documents.

The foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments. For example, the described implementations include software, but systems and methods consistent with the disclosed embodiments be implemented as a combination of hardware and software or in hardware alone. Examples of hardware include computing or processing systems, including personal computers, servers, laptops, mainframes, micro-processors and the like. Additionally, although aspects of the disclosed embodiments are described as being stored in memory, one skilled in the art will appreciate that these aspects can also be stored on other types of computer readable media, such as secondary storage devices, for example, hard disks, floppy disks, or CD ROM, or other forms of RAM or ROM, USB media, DVD, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, HTML, HTML/AJAX combinations, XML, or HTML with included Java applets. One or more of such software sections or modules can be integrated into a computer system or existing e-mail or browser software.

Moreover, while illustrative embodiments have been described herein, the scope includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps. It is intended, therefore, that the specification and examples be considered as exemplary only, with a true scope and spirit being indicated by the following claims and their full scope of equivalents.

What is claimed is:

1. A computer system, comprising:
one or more processors;
one or more storage devices storing patent-related documents; and
stored instructions configured to instruct the computer system to:
receive a search query from a user computer system;
perform a search for patent-related documents based on the search query;
retrieve a results set of documents as a result of the search, the retrieved results set including, for at least one of the patent-related documents, a plurality of patent family duplicate documents;
remove one or more patent family duplicate documents associated with the at least one of the patent related documents prior to returning the patent family duplicate documents to the user computer system, thereby creating a second results set that does not include the removed one or more patent family duplicate documents; and
provide a user interface for viewing the second results set, the user interface including at least a first display area for displaying different view formats for documents in the second results set.

2. The computer system of claim 1, wherein the instructions are further configured to instruct the computer system to remove all patent family duplicate documents from the retrieved results set prior to returning the patent family duplicate documents to the user computer system.

3. The computer system of claim 2, wherein the instructions are further configured to instruct the computer system to remove the patent family duplicate documents based on a preferred authority.

4. The computer system of claim 3, wherein the instructions are further configured to instruct the computer system to further remove patent family duplicate documents based on a date associated with the duplicate documents.

5. The computer system of claim 1, wherein:
the user interface further includes a second display area for displaying different view formats for documents in the second results set, and wherein the user interface is configured to permit a user to view documents in a first view format in the first display area and a second view format in the second display area, wherein the first view format and second view format are different view formats.

6. The computer system of claim 5, wherein:
the user interface is configured to permit a user to view a document in the first view format in the first display area in a first language and to simultaneously view the same document in the same first view format in the second display area in a second language, wherein the first language is different from the second language.

7. The computer system of claim 1, wherein:
the search query includes a first set of search terms in a first language,
performing the search includes searching for the first set of search terms in previously stored first-language translations of documents that are natively published in a second language that is different from the first language; and
retrieving the results set of documents includes retrieving the documents published in the second language, based on the set of search terms submitted in the first language.

8. A method of automatically sending an alert message when the status of one or more documents has changed, comprising:
receiving, by a computer system, instructions from a user to monitor the status of a first type of information for a first selected document;
monitoring, by the computer system, the status of the first type of information for the first selected document; and
when the status of the first type of information for the first selected document has changed, sending, by the computer system, an alert message to the user to indicate that the status of the document has changed.

9. The method of claim 8, wherein:
the first selected document is a patent-related document;
the particular type of information is legal status information;
monitoring the status of the first type of information for the first selected patent-related document includes monitoring the legal status of the first selected patent-related document; and
sending the alert message to the user includes sending an e-mail message to the user indicating that the status of the first selected patent-related document has changed.

10. The method of claim 9, wherein the e-mail message includes a copy of at least a portion of the first selected patent-related document.

11. The method of claim 8, wherein:
the first type of information is citation information;
monitoring the status of the first type of information for the first selected document includes monitoring whether the first selected document is cited in a subsequently published document; and
after the first selected document has been cited in a subsequently published document, sending the alert message to the user.

12. The method of claim 11, wherein:
the alert message indicates that the first selected document has been cited in a subsequently published document.

13. The method of claim 8, further comprising:
receiving, by the computer system, instructions from the user to monitor the status of a second type of information for the first selected document;
monitoring, by the computer system, the status of the second type of information for the first selected document; and
when the status of either the first type of information or the second type of information for the first selected document has changed, sending, by the computer system, an alert message to the user to indicate that the status of the first selected document has changed.

14. The method of claim 8, further comprising:
receiving, by a computer system, instructions from a user to monitor the status of the first type of information for a second selected document;
monitoring, by the computer system, the status of the first type of information for the second selected document; and
when the status of the first type of information for the second selected document has changed, sending, by the computer system, an alert message to the user to indicate that the status of the second selected document has changed.

15. A method of searching for documents, comprising:
receiving, by a computer system, an indication of a selected set of documents to analyze, the documents including a plurality of fields of information;
receiving, by the computer system, an indication of a first selected field of the plurality of fields;
in response to receiving the indication of the selected set of documents and the indication of first selected field, providing, by the computer system, a first graphical display that categorizes the first selected field into a plurality of first sub-categories, and graphically displays the first sub-categories;
receiving, by the computer system, a selection of a portion of the first graphical display or of textual information associated with the portion of the first graphical display, thereby receiving a selection of one of the first sub-categories of the first selected field; and
in response to receiving the selection, providing, by the computer system, a list of documents that include information common to the selected first sub-category.

16. The method of claim 15, wherein:
the first graphical display is a chart;
receiving the selection of the portion of the first graphical display or of textual information associated with the portion of the first graphical display includes receiving a selection of a portion of the chart or of textual information associated with the portion of the chart; and
in response to receiving the selection of the portion of the chart or of the textual information associated with the portion of the chart, providing for display the chart having the portion highlighted, and providing for display simultaneously with the highlighted chart, the list of documents that include information common to the selected first sub-category.

17. The method of claim 16, further comprising:
receiving, by the computer system, an indication of a second selected field of the plurality of fields;
in response to receiving the indication of the second selected field, providing, by the computer system, a second graphical display that categorizes the second selected field into a plurality of second sub-categories, and graphically displays the second sub-categories;
receiving, by the computer system, a selection of a portion of the second graphical display or of textual information associated with the portion of the second graphical display, thereby receiving a selection of one of the second sub-categories of the second selected field; and
in response to receiving the selection, providing, by the computer system, a list of documents that include information common to the selected first sub-category and the selected second sub-category.

18. The method of claim 15, wherein the selected set of documents includes one or more of: at least one patent and at least one published patent application, and the list of documents includes a list of one or more of at least one patent and at least one published patent application.

19. The method of claim 15, wherein:
the selected set of documents includes one or more of: at least one patent and at least one published patent application, the set of documents selected by a user from a work folder displayed in a graphical user interface (GUI), and
the first graphical display and the list of documents are provided to the user for display in the same GUI as the work folder.
